(19) United States
(12) Patent Application Publication
(10) Pub. No.: US 2012/0178012 A1
(43) Pub. Date: Jul. 12, 2012

(54) SEALING MEMBER FOR SOLID OXIDE FUEL CELL AND SOLID OXIDE FUEL CELL EMPLOYING THE SAME

(75) Inventors: Kyong Bok Min, Gyunggi-do (KR); Jong Ho Chung, Gyunggi-do (KR); Jae Hyuk Jang, Seoul (KR)

(73) Assignee: SAMSUNG ELECTRO-MECHANICS CO., LTD., Gyunggi-do (KR)

(21) Appl. No.: 13/340,137

(22) Filed: Dec. 29, 2011

(30) Foreign Application Priority Data
Jan. 12, 2011 (KR) 1020110003104

(51) Int. Cl. H01M 2/08; H01M 8/10; H01M 8/24

(52) U.S. Cl. 429/465; 429/469; 429/495

(57) ABSTRACT

Disclosed herein are a sealing member for a solid oxide fuel cell and a solid oxide fuel cell employing the same. The sealing member for a solid oxide fuel cell includes: a glass sheet; and mica layers formed on both surfaces of the glass sheet. The sealing member can have excellent airtightness and bonding capability, proper flow characteristics, and high electric resistivity, by constituting the sealing member of the glass sheet and the mica layers.

### CROSS REFERENCE TO RELATED APPLICATION

This application claims the benefit of Korean Patent Application No. 10-2011-0003104, filed on Jan. 12, 2011, entitled “A Sealing Element for Solid Oxide Fuel Cell and Solid Oxide Fuel Cell Employing the Same”, which is hereby incorporated by reference in its entirety into this application.

### BACKGROUND OF THE INVENTION

1. Technical Field

The present invention relates to a sealing member for a solid oxide fuel cell and a solid oxide fuel cell employing the same.

2. Description of the Related Art

A fuel cell is an apparatus that directly converts chemical energy of fuel (hydrogen, LNG, LPG, or the like) and oxygen (air) into electricity and heat by electrochemical reaction. The existing electricity generation technology has been developed by including procedures of fuel combustion, steam generation, turbine driving, generator driving, and the like. However, the fuel cell does not require fuel combustion or turbine driving, resulting in high efficiency and few environmental problems, and thus, it is a new concept of electricity generation technology. The fuel cell barely discharges air pollutants such as SOx, NOx, or the like, and generate less carbon dioxide, so that it can implement chemical-free, low-noise, non-vibration generation, or the like.

There are various types of fuel cells, such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), and the like. Among them, the solid oxide fuel cell (SOFC) has a low overvoltage and a small irreversible loss, resulting in high generating efficiency. Further, the SOFC does not need expensive precious metals as an electrode catalyst since the reaction rate in electrodes is high. Therefore, the solid oxide fuel cell is a generation technology needed in order to enter a hydrogen economy society in the future.

FIG. 10 is a conceptual diagram showing a generation principle of a solid oxide fuel cell.

Reviewing a basic generation principle of a solid oxide fuel cell (SOFC) with reference to FIG. 10, when fuel is hydrogen (H₂) or carbon monoxide (CO), the following electrode reaction is performed in an anode 1 and a cathode 2.

Anode: CO+H₂O→H₂+CO₂
2H₂+2O²⁻→4e⁻+2H₂O

Cathode: O₂+4e⁻→2O²⁻

Total reaction: H₂+CO+O₂→CO₂+H₂O

That is, electrons (e⁻) generated in the anode 1 are transferred to the cathode 2 through an external circuit 4 and at the same time, oxygen ions (O²⁻) generated in the cathode 2 are transferred to the anode 1 through an electrolyte 3. In addition, hydrogen (H₂) is combined with oxygen ion (O²⁻) in the anode 1, to generate electrons (e⁻) and water (H₂O). As a result, in the total reaction of the solid oxide fuel cell, hydrogen (H₂) or carbon monoxide (CO) are supplied to the anode 1 and oxygen is supplied to the cathode 2, with the result that carbon dioxide (CO₂) and water (H₂O) are generated.

As described above, the solid oxide fuel cell needs to receive air, hydrogen, or the like in order to generate electric energy. However, when the supplied air or hydrogen is leaked or the air and hydrogen are mixed together within the solid oxide fuel cell, generating efficiency is rapidly dropped and the solid oxide fuel cell may be damaged due to rapid power generation or explosion due to an oxidation reaction of hydrogen. Therefore, a sealing member is used to prevent the air or hydrogen from being leaked or from being mixed together within the solid oxide fuel cell.

Here, the sealing member needs to satisfy the following conditions.

First, the sealing member needs to have superior airtightness and bonding capability in order to prevent gas such as air or hydrogen from being leaked at an operating temperature.

Second, the sealing member needs to have a coefficient of thermal expansion similar to those of components of the solid oxide fuel cell in order to prevent cracks and destruction due to thermal stress among constituent elements of the solid oxide fuel cell during a bonding process or operating of the solid oxide fuel cell, and minimize thermal impact due to a sudden stop while operating of the solid oxide fuel cell.

Third, the sealing member needs to have proper flow characteristics in order to maintain structural stability at an operating temperature and preventing itself from flowing down. That is, very low viscosity (10⁹dPa·s or lower) causes an unstable structure, resulting in deformation, and very high viscosity (10¹⁵dPa·s or higher) may cause inferior airtightness and bonding capability, and thus, preferably, the sealing member has a viscosity of 10⁹dPa·s to 10¹⁵dPa·s.

Fourth, the sealing member needs to have high electric insulating property in high-temperature oxidizing/reducing atmosphere. If current flows through the sealing member, short circuits may occur. Therefore, the sealing member preferably has a high electric resistivity of 2 KΩ·cm or more.

Fifth, the sealing member should not be decomposed or evaporated in the high-temperature oxidizing/reducing atmosphere. Also, the sealing member needs to be chemically stable as well as economically cheap, and allow simple manufacturing and bonding processes.

As such, the sealing member needs to satisfy various conditions in order to stably drive the solid oxide fuel cell. However, the sealing member satisfying the above conditions has not existed until now, and therefore, the solid oxide fuel cell is difficult to be commercialized.

### SUMMARY OF THE INVENTION

The present invention has been made in an effort to provide a sealing member for a solid oxide fuel cell, which meets the requirements necessary as a sealing member, such as excellent airtightness, bonding capability, and the like, and a solid oxide fuel cell employing the same.

According to one preferred embodiment of the present invention, there is provided a sealing member for a solid oxide fuel cell, including: a glass sheet; and mica layers formed on both surfaces of the glass sheet.

The glass sheet may contain ZnO.

The glass sheet may be formed by a tape casting process.

According to another preferred embodiment of the present invention, there is provided a solid oxide fuel cell employing a sealing member, including: two or more planar unit cells facing and paralleling each other with a predetermined distance therebetween, each of the planar unit cells being formed by stacking an anode, an electrolyte, and a cathode in a planar type; a separator disposed between the planar unit cells and having air passages supplying gas to the planar unit cells; and a sealing member constituted of a glass sheet and mica layers formed on both surfaces of the glass sheet, and disposed between an edge of the planar unit cell and an edge of the separator to seal the planar unit cell and the separator.

The glass sheet may contain ZnO.

The glass sheet may be formed by a tape casting process.

According to still another preferred embodiment of the present invention, there is provided a solid oxide fuel cell employing a sealing member, including: a tubular unit cell formed by stacking an anode, an electrolyte, and a cathode in a tubular type; a manifold combined with one end of the tubular unit cell to supply gas into the tubular unit cell; and a sealing member constituted of a glass sheet and mica layers formed on both surfaces of the glass sheet, and provided between one end of the tubular unit cell and the manifold to seal the tubular unit cell and the manifold.

The glass sheet may contain ZnO.

The glass sheet may be formed by a tape casting process.

The tubular unit cell may be in a cylindrical type or a flat tubular type.

The tubular unit cell may include a metal supporter formed in a tubular type to support the anode, the electrolyte, and the cathode from the inside.

### BRIEF DESCRIPTION OF THE DRAWINGS

FIG. 1 is a cross-sectional view of a sealing member for a solid oxide fuel cell according to one preferred embodiment of the present invention;

FIG. 2 is an exploded perspective view of a planar solid oxide fuel cell employing a sealing member according to another preferred embodiment of the present invention;

FIG. 3 is an enlarged cross-sectional view of a main part of the planar solid oxide fuel cell employing a sealing member according to the preferred embodiment of the present invention;

FIG. 4 is a plan view of a tubular solid oxide fuel cell employing a sealing member according to still another preferred embodiment of the present invention;

FIGS. 5 and 6 are enlarged longitudinal cross-sectional views of main parts of the tubular solid oxide fuel cell employing a sealing member according to the preferred embodiment of the present invention;

FIGS. 7 to 9 are enlarged lateral cross-sectional views of main parts of the tubular solid oxide fuel cell employing a sealing member according to the preferred embodiment of the present invention; and

FIG. 10 is a conceptual diagram showing a generation principle of a solid oxide fuel cell.

### DESCRIPTION OF THE PREFERRED EMBODIMENTS

Various objects, advantages and features of the invention will become apparent from the following description of preferred embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known art related to the present invention will be omitted so as not to unnecessarily obscure the subject of the present invention.

Hereinafter, preferred embodiments of the present invention will be described in detail with reference to the accompanying drawings.

Sealing Member For Solid Oxide Fuel Cell

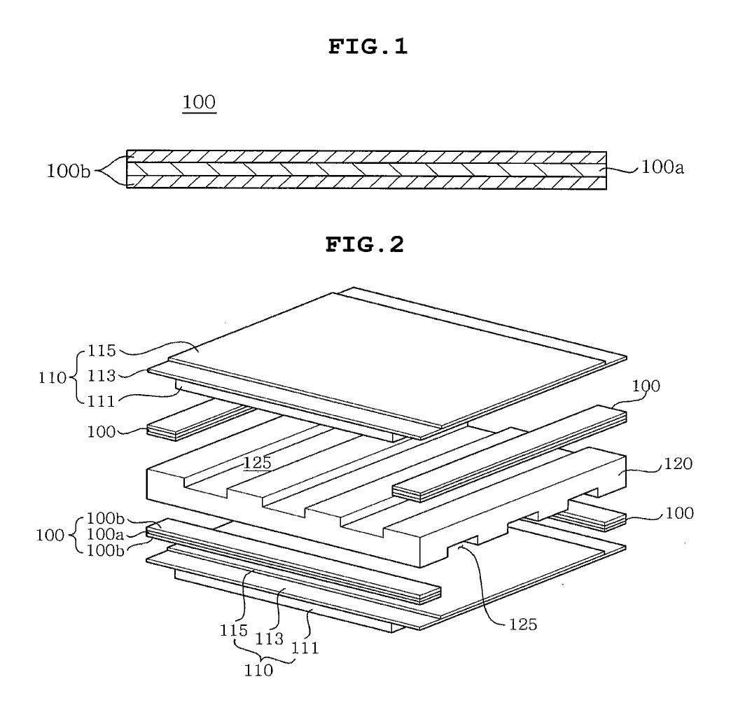

FIG. 1 is a cross-sectional view of a sealing member for a solid oxide fuel cell according to one preferred embodiment of the present invention.

As shown in FIG. 1, a sealing member 100 for a solid oxide fuel cell according to one preferred embodiment of the present invention includes a glass sheet 100a, and mica layers 100b formed on both surfaces of the glass sheet 100a.

The glass sheet 100a serves as a support of the sealing member 100, and it is preferably formed of BaO—SiO₂—ZnO based glass. Here, SiO₂, which is a glass forming material, has a small coefficient of thermal expansion, and thus, BaO having a relatively large coefficient of thermal expansion is contained thereinto, so that a coefficient of thermal expansion of the glass sheet 100a can be appropriately realized. In addition, ZnO has capabilities to increase surface tension and improve chemical durability of glass. In particular, various kinds of crystalline phases are generated while the glass sheet 100a containing ZnO are crystallized. Therefore, a glass powder containing BaO and ZnO can be converted into crystallized glass made of several crystalline phases of BaAl₂Si₂O₈, ZnBa₂Si₂O₇, Zn₂SiO₄ and the like, by heat treatment at 1000° C. to 1100° C. Meanwhile, the glass sheet 100a containing BaO and ZnO has a coefficient of thermal expansion of 10×10⁻⁶/°C. to 11×10⁻⁶/°C., which is similar to coefficients of thermal expansion of constituent elements of the solid oxide fuel cell. Therefore, the sealing member 100 including the glass sheet 100a can prevent cracks and destruction due to thermal stress among constituent elements of the solid oxide fuel cell, and minimize thermal impact even though operation of the solid oxide fuel cell is suddenly stopped. In addition, the glass sheet 100a has a high electric resistivity of 2 KΩ·cm or higher, thereby preventing short circuits from occurring inside the solid oxide fuel cell. Meanwhile, the glass sheet 100a is preferably formed by a tape casting process, but is not necessarily limited thereto.

The mica layers 100b are formed on both surfaces of the glass sheet 100a and contacted with the constituent elements of the solid oxide fuel cell. The mica layer 100b may be constituted of Ka₁₂(AlSi₃O₁₀) (F—OH)₂ called muscovite, KMg₃(AlSi₃O₁₀) (OH)₂ called phlogopite, and the like. Here, the mica layer 100b may be formed by coating mica paste on the glass sheet 100a. If, the sealing member 100 is constituted of the glass sheet 100a alone, without the mica layers 100b, the glass sheet 100a is fused and attached with the constituent elements of the solid oxide fuel cell, and then may be damaged due to thermal stress caused by rapid cooling or repeated heating/cooling cycles. Further, in a case where the sealing member 100 is exposed to a high temperature of 700° C. or higher for a long time while the solid oxide fuel cell is operated, the structure of the glass sheet 100a becomes weakened, which may cause deterioration in airtightness. However, the sealing member 100 according to the present preferred embodiment can prevent the glass sheet 100a from being damaged, and airtightness from being deteriorated even though it is exposed to a high temperature for a long time, by forming the mica layers 100b on both surfaces of the glass sheet 100a and thereby to mitigate the thermal stress. Further, the mica layers 100b allow the sealing member 100 to be easily attached to and detached from the sold oxide fuel cell, and thus, deterioration in performance can be checked at anytime.

Planar Solid Oxide Fuel Cell Employing Sealing Member

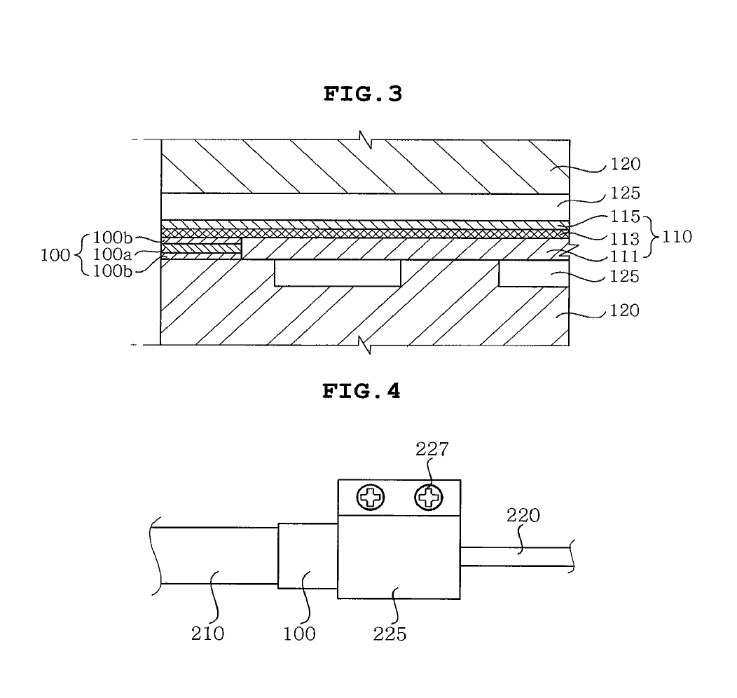

FIG. 2 is an exploded perspective view of a planar solid oxide fuel cell employing a sealing member according to another preferred embodiment of the present invention, and FIG. 3 is an enlarged cross-sectional view of a main part of the planar solid oxide fuel cell employing a sealing member according to the preferred embodiment of the present invention.

As shown in FIGS. 2 and 3, a planar solid oxide fuel cell according to the present preferred embodiment includes: two or more planar unit cells 110 facing and paralleling each other with a predetermined distance therebetween, each of the planar unit cells 110 being formed by stacking an anode 111, an electrolyte 113, and a cathode 115 in a planar type; a separator 120 disposed between the planar unit cells 110 and having air passages 125 supplying gas to the planar unit cells 110; and a sealing member 100 constituted of a glass sheet 100a and mica layers 100b formed on both surfaces of the glass sheet 110a, and disposed between an edge of the planar unit cell 110 and an edge of the separator 120 to seal the planar unit cell 110 and the separator 120.

The planar unit cell 110 serves to generate electric energy, and it is formed by stacking the anode 111, the electrolyte 113, and the cathode 115 in a planar type. In addition, the two or more planar unit cells 110 are disposed in parallel with each other therebetween such that the anode 111 and the cathode 115 face each other, and the separator 120 is disposed between the planar unit cells 110.

Here, the anode 111 receives fuel through the gas passages 125 of the separator 120 to perform an anode function by an electrode reaction. Here, the anode 111 is formed by using nickel oxide (NiO) and yttria stabilized zirconia (YSZ). Nickel oxide is reduced to the metal nickel by hydrogen to exhibit electronic conductivity, and yttria stabilized zirconia (YSZ) exhibits ion conductivity as oxide.

In addition, the electrolyte 113 serves to transfer oxygen ions generated in the cathode 115 to the anode 111. Here, the electrolyte 113 may be formed by sintering yttria stabilized zirconia or scandium stabilized zirconia (ScSz), GDC, LDC, or the like. Here, in yttria stabilized zirconia, some of the tetravalent zirconium ions are substituted with trivalent yttrium ions, and thus, one oxygen ion hole per two yttrium ions is generated inside, and the oxygen ions move through the hole at a high temperature. In addition, it should be noted that scratches is not generated because a crossover phenomenon that fuel reacts with oxygen (air) directly may occur when pores are generated in the electrolyte 113, resulting in degradation in efficiency.

Here, the cathode 115 receives oxygen or air through the gas passages 125 of the separator 120 to perform a cathode function by an electrode reaction. Here, the cathode 115 may be formed by sintering lanthanum strontium manganite ((La_{0.84} Sr_{0.16}) MnO₃) or the like, which has high electronic conductivity. Meanwhile, in the cathode 115, oxygen is converted into oxygen ions by a catalytic action of lanthanum strontium manganite, and then transferred to the anode 111 via the electrolyte 113.

The separator 120 is disposed between the two planar unit cells 110, and thereby to serve to separate fuel and oxygen (air) from each other and electrically connect in series the planar unit cells 110. Here, one surface of the separator 120 contacted with the cathode 115 of the planar unit cell 110 is in an oxidizing atmosphere, and the other surface of the separator 120 contacted with the anode 111 of the planar unit cell 110 is in a reducing atmosphere. In addition, preferably, the separator 120 has high electron conductivity and low ion conductivity in order to connect in series the planar unit cells 110.

The sealing member 100 serves to seal the planar unit cells 110 and the separator 120, and provided between an edge of the planar unit cell 110 and an edge of the separator 120. Here, the sealing member 100 is constituted of a glass sheet 100a and mica layers 100b formed on both surfaces of the glass sheet 100a, as described in the above preferred embodiment. The glass sheet 100a may contain ZnO, and may be formed by a tape casting process. The glass sheet 100a and the mica layers 100b are employed for the sealing member 110, with the result that the efficient of thermal expansion of the sealing member 100 can be similar to the coefficients of thermal expansion of the planar unit cell 110 and the separator 120. Therefore, the sealing member 100 can minimize thermal impact even thought the operation of the planar solid oxide fuel cell is suddenly stopped. Further, the sealing member 100 contain the mica layers 100b and thereby to mitigate thermal stress, and thus, it can prevent the glass sheet 100a from being damaged, and can prevent airtightness thereof from being deteriorated despite exposure for a long time.

Meanwhile, the sealing member 100 in the drawing is formed in a direction parallel with the gas passage 125 of the separator 120, but is not limited thereto. For example, the sealing member 100 may completely surround the edges of the planar unit cell 110 and the separator 120.

Tubular Solid Oxide Fuel Cell Employing Sealing Member

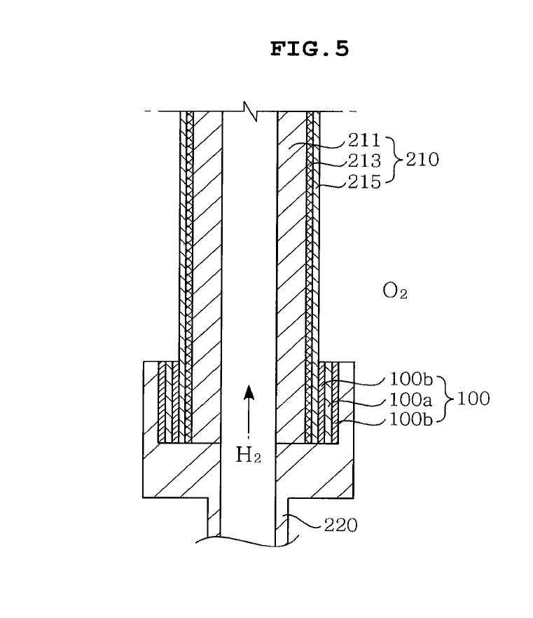

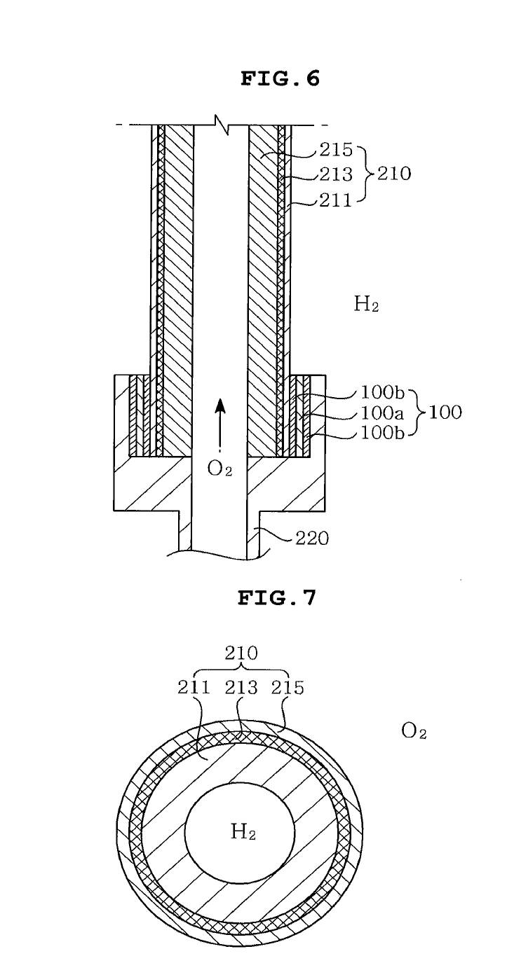

FIG. 4 is a plan view of a tubular solid oxide fuel cell employing a sealing member according to still another preferred embodiment of the present invention; FIGS. 5 and 6 are enlarged longitudinal cross-sectional views of main parts of the tubular solid oxide fuel cell employing a sealing member according to the preferred embodiment of the present invention; and FIGS. 7 to 9 are enlarged lateral cross-sectional views of main parts of the tubular solid oxide fuel cell employing a sealing member according to the preferred embodiment of the present invention.

As shown in FIGS. 4 to 9, the tubular solid oxide fuel cell according to the present preferred embodiment includes: a tubular unit cell 210 formed by stacking an anode 211, an electrolyte 213, and a cathode 215 in a tubular type; a manifold 220 combined with one end of the tubular unit cell 210 to supply gas into the tubular unit cell 210; and a sealing member 100 including a glass sheet 100a and mica layers 100b formed on both surfaces of the glass sheet 100a, and provided between one end of the tubular unit cell 210 and the manifold 220 to seal the tubular unit cell 210 and the manifold 220.

The tubular unit cell 210 serves to generate electric energy, and it is formed by stacking the anode 211, the electrolyte 213, and the cathode 215 in a tubular type.

Here, the anode 211, the electrolyte 213, and the cathode 215 of the tubular type unit cell 210 are the same as the anode 111, the electrolyte 113, and the cathode 115 of the above-described planar unit cell 110 except that they are stacked in a tubular type, and thus detailed descriptions thereof will be omitted.

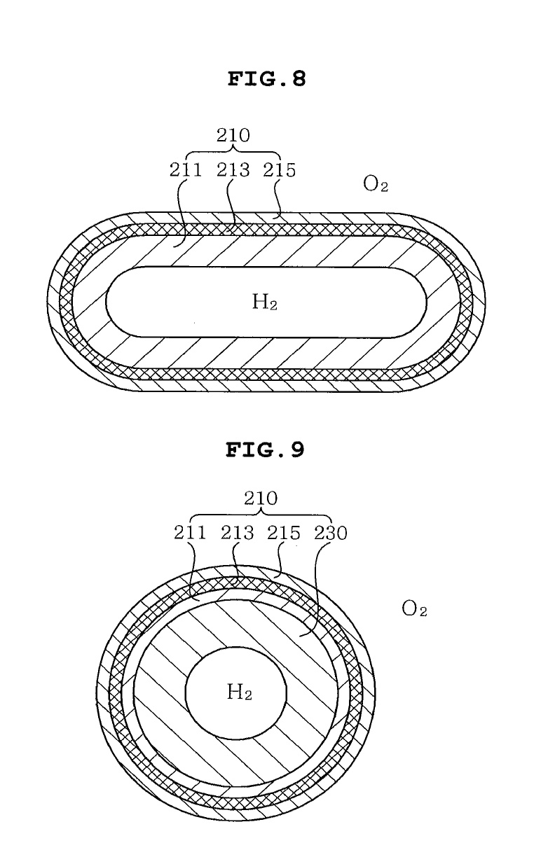

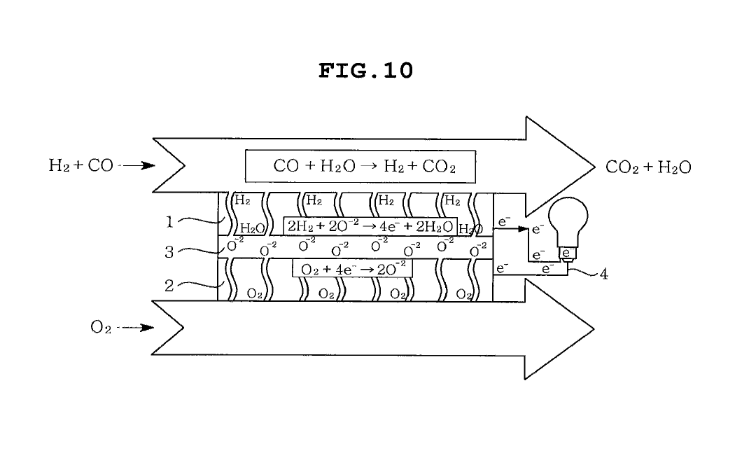

Meanwhile, a shape of the tubular unit cell 210 may be particularly not limited as long as it is a tubular type, but it is preferably a cylindrical shape (see, FIG. 7) and a flat tubular shape (see, FIG. 8). In addition, the tubular unit cell 210 is drawn in an anode-supporter manner in which the anode 211 is used as a supporter (see, FIG. 5), and in a cathode-supporter manner in which the cathode 215 is used as a supporter (see, FIG. 6), but it is not limited thereto. In other words, the tubular unit cell 210 may be in an electrolyte-supporter manner in which the electrolyte 213 is used as a supporter. Further, as shown in FIG. 9, a metal supporter 230 formed in a tubular type is provided to support the anode 211, the electrolyte 213, and the cathode 215 inside the tubular unit cell 210.

The manifold 220 is combined with one end of the tubular unit cell 210 to serve to supply gas into the tubular unit cell 210 therethrough. In other words, the manifold 220 supplies fuel therethrough when the anode 211 is provided inside the tubular unit cell 210 as shown in FIG. 5, and the manifold 220 supplies air (oxygen) therethrough when the cathode 215 is inside the tubular unit cell 210, as shown in FIG. 6. In general, the manifold 220 is formed of metal and the tubular unit cell 210 is formed of ceramics, and thus both are formed of different kinds of materials. Therefore it is difficult to completely seal the manifold 220 and the tubular unit cell 210 to prevent leakage of gas. However, in the present preferred embodiment, the below-described sealing member 100 can be employed to completely seal the manifold 220 and the tubular unit cell 210.

The sealing member 100 (see, FIGS. 5 and 6) serves to seal the tubular unit cell 210 and the manifold 220, and provided between one end of the tubular unit cell 210 and the manifold 220. Here, the sealing member 100 is constituted of a glass sheet 100a and mica layers 100b formed on both surfaces of the glass sheet 100a, as described in the above preferred embodiment. The glass sheet 100a may contain ZnO, and may be formed by a tape casting process. The glass sheet 100a and the mica layers 100b are employed for the sealing member 210, with the result that the coefficient of thermal expansion of the sealing member 100 can be similar to the coefficients of thermal expansion of the tubular unit cell 210 and the manifold 220. Therefore, the sealing member 100 can minimize thermal impact even thought the operation of the planar solid oxide fuel cell is suddenly stopped. Further, the sealing member 100 contain the mica layers 100b and thereby to mitigate thermal stress, and thus, it can prevent the glass sheet 100a from being damaged, and can prevent airtightness thereof from being deteriorated despite exposure for a long time. Meanwhile, in order to secure the airtightness of the sealing member 100, it is preferable to compress the sealing member 100 by completely surrounding an end 225 of the manifold 220 combined with the tubular unit cell 210 with the sealing member 100 and tightening the end 225 of the manifold 220 by using screws 227 or the like, as shown in FIG. 4.

According to the present invention, the sealing member can have excellent airtightness and bonding capability, proper flow characteristics, and high electric resistivity, by constituting the sealing member of the glass sheet and the mica layers.

Further, according to the present invention, the sealing member can be economically cheap and a bonding process for the sealing member can be simplified, by constituting the sealing member of the glass sheet and the mica layers.

Further, according to the present invention, cracks and destruction due to thermal stress can be prevented and thermal impact due to sudden stop during operating of the solid oxide fuel cell can be minimized, by making a coefficient of thermal expansion of the sealing member be similar to coefficients of thermal expansion of the constituent elements of the solid oxide fuel cell.

Although the preferred embodiments of the present invention have been disclosed for illustrative purposes, they are for specifically explaining the present invention and thus a sealing member for a solid oxide fuel cell and a solid oxide fuel cell employing the same according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A sealing member for a solid oxide fuel cell, comprising:
a glass sheet; and
mica layers formed on both surfaces of the glass sheet.

2. The sealing member for a solid oxide fuel cell as set forth in claim 1, wherein the glass sheet contains ZnO.

3. The sealing member for a solid oxide fuel cell as set forth in claim 1, wherein the glass sheet is formed by a tape casting process.

4. A solid oxide fuel cell employing a sealing member, comprising:
two or more planar unit cells facing and paralleling each other with a predetermined distance therebetween, each of the planar unit cells being formed by stacking an anode, an electrolyte, and a cathode in a planar type;
a separator disposed between the planar unit cells and having air passages supplying gas to the planar unit cells; and
a sealing member constituted of a glass sheet and mica layers formed on both surfaces of the glass sheet, and disposed between an edge of the planar unit cell and an edge of the separator to seal the planar unit cell and the separator.

5. The solid oxide fuel cell as set forth in claim 4, wherein the glass sheet contains ZnO.

6. The solid oxide fuel cell as set forth in claim 4, wherein the glass sheet is formed by a tape casting process.

7. A solid oxide fuel cell employing a sealing member, comprising:
a tubular unit cell formed by stacking an anode, an electrolyte, and a cathode in a tubular type;
a manifold combined with one end of the tubular unit cell to supply gas into the tubular unit cell; and
a sealing member constituted of a glass sheet and mica layers formed on both surfaces of the glass sheet, and provided between one end of the tubular unit cell and the manifold to seal the tubular unit cell and the manifold.

8. The solid oxide fuel cell as set forth in claim 7, wherein the glass sheet contains ZnO.

9. The solid oxide fuel cell as set forth in claim 7, wherein the glass sheet is formed by a tape casting process.

10. The solid oxide fuel cell as set forth in claim 7, wherein the tubular unit cell is in a cylindrical type or a flat tubular type.

11. The solid oxide fuel cell as set forth in claim 7, wherein the tubular unit cell includes a metal supporter formed in a tubular type to support the anode, the electrolyte, and the cathode therein.
